(19) United States
(12) Patent Application Publication
(10) Pub. No.: US 2006/0263290 A1
(43) Pub. Date: Nov. 23, 2006

(54) Method for the production of chlorine

(75) Inventors: Christian Walsdorff, Ludwigshafen (DE); Martin Fiene, Niederkirchen (DE); Martin Sesing, Waldsee (DE); Olga Metelkina, Ludwigshafen (DE); Lothar Seidemann, Mannheim (DE); Eckhard Stroefer, Mannheim (DE); Klaus Harth, Altleiningen (DE)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/567,579

(22) PCT Filed: Aug. 6, 2004
(86) PCT No.: PCT/EP04/08872

§ 371 Date: Jun. 20, 2006

(30) Foreign Application Priority Data
Aug. 8, 2003 (DE) 103 36 522.2

(51) Int. Cl. C01B 7/00

(52) U.S. Cl. 423/507

(57) ABSTRACT

The invention relates to a process for preparing chlorine by catalytic gas-phase oxidation of hydrogen chloride, which comprises the steps: a) providing a feed gas stream I comprising hydrogen chloride and a feed gas stream II comprising oxygen; b) in a first oxidation stage, feeding the feed gas stream I, the feed gas stream II, if desired a recycle stream la comprising hydrogen chloride and if desired an oxygen-containing recycle stream IIa into a first oxidation zone and bringing them into contact with a first oxidation catalyst so that a first partial amount of the hydrogen chloride is oxidized to chlorine and a gas stream III comprising chlorine, unreacted oxygen, unreacted hydrogen chloride and water vapor is obtained; c) in a second oxidation stage, feeding the gas stream III into a second oxidation zone and bringing it into contact with at least one further oxidation catalyst so that a second partial amount of the hydrogen chloride is oxidized to chlorine and a product gas stream IV comprising chlorine, unreacted oxygen, unreacted hydrogen chloride and water vapor is obtained; d) isolating chloride, if desired the recycle stream Ia and if desired the recycle stream IIa from the product gas stream IV, wherein the first oxidization catalyst in the first oxidation zone is present in a fluidized bed and the further oxidation catalyst or catalysts in the second oxidation zone is/are present in a fixed bed.

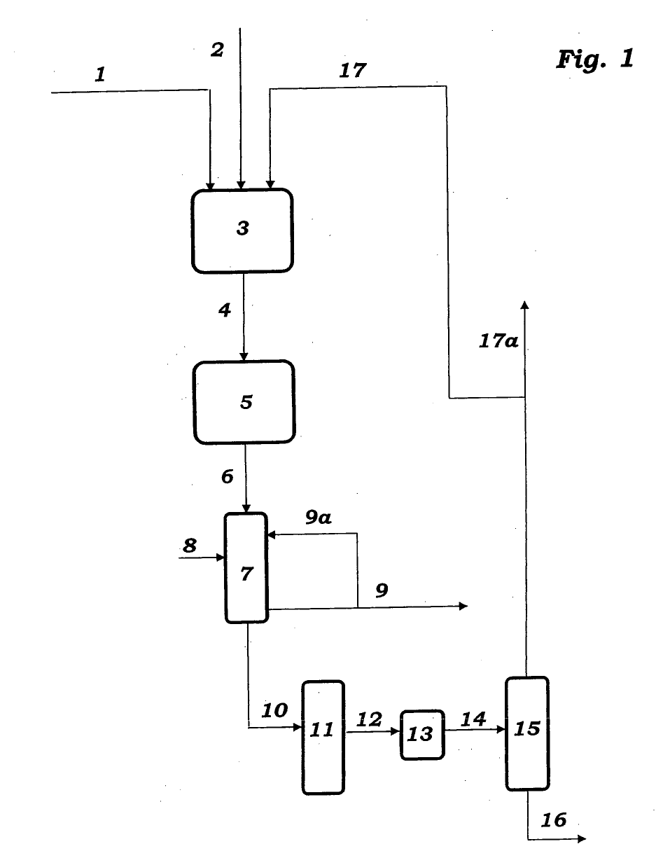

In the process developed by Deacon in 1868 for the catalytic oxidation of hydrogen chloride, hydrogen chloride is oxidized to chlorine by means of oxygen in an exothermic equilibrium reaction. The conversion of hydrogen chloride into chlorine enables chlorine production to be decoupled from the production of sodium hydroxide by chloralkali electrolysis. Such decoupling is attractive since the world demand for chlorine is growing more quickly than the demand for sodium hydroxide. In addition, hydrogen chloride is obtained in large quantities as coproduct in, for example, phosgenation reactions, for example in isocyanate production. The hydrogen chloride formed in isocyanate production is mostly used in the oxychlorination of ethylene to 1,2-dichloroethane, which is further processed to vinyl chloride and finally to PVC. The Deacon process thus also makes decoupling from isocyanate production and vinyl chloride production possible.

EP-B 0 233 773 describes the catalytic oxidation of hydrogen chloride over pulverulent chromium oxide catalysts in a fluidized-bed process.

Fluidized-bed processes make it possible to operate the process very isothermally. In this way, the formation of local regions of overheating in the catalyst bed, namely the formation of “hot spots”, can be largely avoided. However, fluidized-bed processes have disadvantages. These include difficulties in scale-up, sometimes considerable discharge of catalyst material with the reaction gases during operation of the fluidized-bed reactor and the risk of instability of the fluidized bed caused by conglutination of catalyst particles. The risk of conglutination of catalyst particles (“sticking”) is particularly great at low operating temperatures.

Fixed-bed processes do not have the disadvantages mentioned. They are generally carried out using tray reactors with intermediate cooling or shell-and-tube reactors. In EP-A-0 936 184, the Deacon reaction is carried out over a fixed catalyst bed using ruthenium catalysts. However, carrying out exothermic reactions over a fixed catalyst bed generally results in the formation of “hot spots”. These adversely affect the life of the catalyst and are therefore to be avoided where possible. Although a number of measures for reducing the risk of formation of hot spots are known, for example the use of catalyst beds diluted with inert material and/or the use of structured catalyst beds whose catalytic activity increases gradually in the flow direction (as a result of different impregnation of the catalyst supports with active components or different dilution of the bed), the formation of hot spots has hitherto not been able to be suppressed completely. In addition, dilution of the catalyst bed reduces the space-time yields possible in the process.

It is an object of the present invention to provide an improved process for preparing chlorine from hydrogen chloride, which remedies the disadvantages of the prior art.

We have found that this object is achieved by a process for preparing chlorine by catalytic gas-phase oxidation of hydrogen chloride, which comprises the steps:

a) providing a feed gas stream I comprising hydrogen chloride and a feed gas stream II comprising oxygen;

b) in a first oxidation stage, feeding the feed gas stream I, the feed gas stream II, if desired a recycle stream la comprising hydrogen chloride and if desired an oxygen-containing recycle stream IIa into a first oxidation zone and bringing them into contact with a first oxidation catalyst so that a first partial amount of the hydrogen chloride is oxidized to chlorine and a gas stream III comprising chlorine, unreacted oxygen, unreacted hydrogen chloride and water vapor is obtained;

c) in a second oxidation stage, feeding the gas stream III into a second oxidation zone and bringing it into contact with at least one further oxidation catalyst so that with a second partial amount of the hydrogen chloride is oxidized to chlorine and a product gas stream IV comprising chlorine, unreacted oxygen, unreacted hydrogen chloride and water vapor is obtained;

d) isolating chlorine, if desired the recycle stream la and if desired the recycle stream IIa from the product gas stream IV,

wherein the first oxidization catalyst in the first oxidation zone is present in a fluidized bed and the further oxidation catalyst or catalysts in the second oxidation zone is/are present in a fixed bed.

An at least two-stage process in which a first partial conversion of hydrogen chloride is achieved in a fluidized-bed reactor stage and a second partial conversion of hydrogen chloride is achieved in one or more fixed-bed reactor stages is thus provided.

Since the Deacon reaction is an exothermic equilibrium reaction, it is advantageous from a thermodynamic point of view to carry it out at the lowest temperatures at which the catalyst still has a sufficient activity to achieve a very high conversion. However, low temperatures are generally associated with low space-time yields. Owing to the evolution of a large amount of heat, high space-time yields generally go together with high temperatures.

The reaction of the first partial amount of hydrogen chloride in the fluidized-bed reactor stage b) can be carried out at high temperatures and high space-time yields since there is no risk of formation of hot spots in a fluidized bed. The high temperatures in the fluidized-bed stage do not adversely affect the maximum total conversion which can be achieved in the process of the present invention, since the thermodynamically achievable conversions are only sought in the second oxidation stage c), i.e. the fixed-bed reactor stage(s). However, this can be operated at significantly lower temperatures to achieve the optimum thermodynamic equilibrium position, which is far to the product side, without excessively great decreases in the space-time yield having to be accepted, since the major part of the conversion is achieved beforehand in the fluidized-bed. Since a partial conversion takes place in the fluidized-bed stage b) and the resulting gas stream III is diluted with product gases, there remains only a small risk of formation of hot spots in the fixed-bed reactor stage c), and this can be reduced further by means of additional measures, for example use of a structured catalyst bed. Since the fluidized-bed reactor stage can be carried out at higher temperatures, the risk of conglutination of catalyst particles in the fluidized bed (also known as “catalyst sticking”) is also reduced.

In a first process step a), a feed gas stream I comprising hydrogen chloride is provided. Hydrogen chloride is obtained, for example, in the preparation of aromatic polyisocyanates such as tolylene diisocyanate (TDI) and diphenylmethane diisocyanate (MDI) from the corresponding polyamines and phosgene, in the preparation of acid chlorides, in the chlorination of aromatics, in the preparation of vinyl chloride and in the preparation of polycarbonates. This hydrogen chloride can contain hydrocarbons or chlorinated hydrocarbons as impurities, for example in amounts of from 100 to 3000 ppm. In addition, further gas constituents such as carbon monoxide, carbon dioxide, nitrogen and further inert gases can also be present, typically in amounts of from 0 to 1% by volume.

The impurities can, for example, be removed from the feed gas stream by catalytic combustion of the hydrocarbons and chlorinated hydrocarbons in the feed gas stream or by absorption of the hydrocarbons and chlorinated hydrocarbons on a suitable absorbent. The hydrocarbons or chlorinated hydrocarbons can also be reacted by combustion in the oxidation stages. In this case, there is in principle a risk of formation of dioxins, particularly when chlorinated hydrocarbons such as monochlorobenzene are present. To avoid formation of dioxins, it is generally necessary for the reaction temperature to be controlled precisely, as occurs in the process of the present invention.

Hydrogen chloride is preferably fed in as a gas. It may be advantageous to feed in a partial amount of the hydrogen chloride as liquid hydrochloric acid in order to utilize the enthalpy of vaporization of the hydrochloric acid and thus to save heat exchanger area in the reactor.

In addition, a feed gas stream II comprising oxygen is provided. The feed gas stream II can consist of pure oxygen, technical-grade oxygen, for example 94% strength by volume or 98% strength by volume industrial oxygen, air or other oxygen/inert gas mixtures. Air is less preferred because of the high proportion of inert gas, and pure oxygen is less preferred for cost reasons.

In a first oxidation stage b), the feed gas stream I, the fed gas stream II, if desired a recycle stream Ia comprising hydrogen chloride and if desired an oxygen-containing recycle stream IIa are fed into a first oxidation zone and brought into contact with a first oxidation catalyst which is present in the first oxidation zone as a fluidized bed.

It is advantageous to use oxygen in superstoichiometric amounts. For example, an HCl:O₂ ratio of from 4:1.5 to 1:1 is usual. Since no decreases in selectivity have to be feared, it can be economically advantageous to work at relatively high pressures and accordingly at residence times which are longer than they would be at atmospheric pressure. Higher pressures lead, owing to the associated lower flow velocities, to an increased risk of hot spots in a pure fixed-bed process, which is circumvented by the process of the present invention.

The first process step is carried out in a fluidized-bed reactor. The fluidized-bed reactor can have a conical or preferably cylindrical shape.

The fluidizing gas formed from the feed gas streams is introduced at the lower end via a distributor or nozzle plate.

Heat exchangers can be built into the fluidized-bed reactor. These can be configured as, for example, shell-and-tube, hairpin, coil or plate heat exchangers. The heat exchangers can be arranged horizontally, vertically or at an angle.

The demixing zone (catalyst particles/gas) above the fluidized-bed in the fluidized-bed reactor, known as the freeboard, is preferably cylindrical. Since the discharge of solids can be reduced with an increasing cross section, it can also be economical to make the freeboard cross section wider than the diameter of the fluidized-bed.

The diameter of the fluidized-bed is generally from 0.1 to 10 m. The freeboard height is generally from 20 to 500%, preferably from 50 to 250% of the height of the fluidized-bed. The empty tube gas velocity in the fluidized-bed is generally from 0.05 to 20 m/s, preferably from 0.1 to 1.0 m/s. The empty tube gas velocity in the freeboard is generally from 0.01 to 2 m/s, preferably from 0.05 to 0.5 m/s. The pressure in the fluidized-bed reactor is generally from 1 to 15 bar. The temperature in the fluidized-bed is generally from 250 to 450° C., preferably from 280 to 360° C. The residence time of the fluidizing gas formed from the feed gas streams in the fluidized bed is generally from 1 to 300 s, preferably from 1 to 30 s.

Oxidation catalysts suitable for the first oxidation stage can comprise ruthenium oxide, ruthenium chloride or other ruthenium compounds on silicon dioxide, aluminum dioxide, titanium dioxide or zirconium dioxide as support. Suitable catalysts can, for example, be obtained by application of ruthenium chloride to the support and subsequent drying or drying and calcination. Suitable catalysts can also comprise, in addition to or in place of a ruthenium compound, compounds of other noble metals, for example, gold, palladium, platinum, osmium, iridium, silver, copper or rhenium. Suitable catalysts can also comprise chromium(III) oxide.

The bulk density of the support of the first oxidation catalyst forming the fluidized bed is from 0.1 to 10 kg/I, preferably from 0.5 to 2 kg/I. The pore volume of the catalyst is from 0.01 to 2 ml/g, preferably from 0.2 to 1.0 ml/g, and the mean particle diameter is from 1 to 1000 μm, preferably from 10 to 200 μm.

A gas stream III comprising chlorine, unreacted oxygen, unreacted hydrogen chloride and water vapor is obtained. Particles of the first oxidation catalyst from the fluidized bed which have been entrained by the gas stream III are separated off from the gas stream III in a solids precipitation step. The precipitation of the solids can be carried out in a cyclone or by means of a solids filter.

If the catalyst is separated off in a cyclone, the separation particle size, i.e. the minimum size of catalyst particles which are retained in the cyclone, is generally from 0.1 to 100 μm, preferably from 1 to 10 μm. If the catalyst is separated off by means of a solids filter, the separation particle size, i.e. the minimum size of solid particles retained by the filter, is generally from 0.01 to 100 μm, preferably from 0.01 to 10 μm. The solids filter can be operated with or without filter cleaning. It is also possible to connect a cyclone and solids filter in series. In addition, to avoid discharge of solids in the event of failure of or damage to the cyclone or the filter candles, an additional “safety net” filter can be installed downstream of the main filter.

The hydrogen chloride conversion in the first oxidation stage b) is generally from 40 to 80%.

In a second oxidation stage c), the gas stream III is fed into a second oxidation zone and brought into contact with at least one further oxidation catalyst, resulting in a second partial amount of the hydrogen chloride being oxidized to chlorine. The further oxidation catalyst or catalysts is/are present in a fixed bed.

Suitable further oxidation catalysts can comprise ruthenium oxide, ruthenium chloride or other ruthenium compounds on silicon dioxide, aluminum dioxide, titanium dioxide or zirconium dioxide as support. Suitable catalysts can, for example, be obtained by application of ruthenium chloride to the support and subsequent drying or drying and calcination. Suitable catalysts can also comprise, in addition to or in place of a ruthenium compound, compounds of other noble metals, for example, gold, palladium, platinum, osmium, iridium, silver, copper or rhenium. Suitable catalysts can also comprise chromium(ill) oxide.

The second oxidation zone can comprise one or more fixed-bed reactors. In a preferred embodiment of the invention, the second oxidation zone comprises precisely one fixed-bed reactor. This can be operated using a structured catalyst bed (see above).

Process step c) can be carried out adiabatically or preferably isothermally or approximately isothermally, preferably in shell-and-tube reactors, over heterogeneous catalysts at reactor temperatures of from 180 to 400° C., preferably from 200 to 350° C., particularly preferably from 220 to 320° C., and a pressure of from 1 to 25 bar, preferably from 1.2 to 20 bar, particularly preferably from 1.5 to 17 bar and in particular from 2.20 to 15 bar.

In one embodiment, a structured catalyst bed in which the catalyst activity increases in the flow direction is used in the second oxidation zone. Such a fixed bed has two or more zones of differing activity. Structuring of the catalyst bed can achieved by use of catalysts of differing activity which are obtained by differing impregnation of the catalysts supports with active composition or by differing dilution of the catalyst with an inert material. As inert material, it is possible to use, for example, rings, cylinders or spheres made of titanium dioxide, zirconium dioxide or mixtures thereof, aluminum oxide, steatite, ceramic, glass, graphite or stainless steel. The inert material preferably has an external shape similar to that of the shaped catalyst bodies.

In one embodiment of the invention, the fixed bed of the second oxidization zone comprises two or more further oxidation catalysts which are located in different zones of the fixed bed, with the activity of the oxidation catalysts decreasing in the flow direction.

In a further embodiment, the second oxidation zone has two or more temperature zones.

The temperatures of the two or more temperature zones can be controlled independently of one another by means of an appropriate number of two or more independent heat exchange circuits. There can be a polarity of temperature zones per fixed-bed reactor. In one embodiment of the invention, the second oxidation zone comprises only one fixed-bed reactor which has two or more temperature zones. The fixed-bed reactor preferably has only one temperature zone.

Suitable shaped catalyst bodies include any shapes; preference is given to pellets, rings, cylinders, stars, wagon wheels or spheres, particularly preferably rings, cylinders or star extrudates.

Suitable heterogeneous catalysts are, in particular, ruthenium compounds or copper compounds on support materials, which may also be doped; preference is given to doped or undoped ruthenium catalysts. Suitable support materials are, for example, silicon dioxide, graphite, titanium dioxide having a rutile or anatase structure, zirconium dioxide, aluminum oxide or mixtures thereof, preferably titanium dioxide, zirconium dioxide, aluminum oxide or mixtures thereof, particularly preferably γ- or δ-aluminum oxide or mixtures thereof.

The supported copper catalysts or supported ruthenium catalysts can, for example, be obtained by impregnation of the supported material with aqueous solutions of CuCl₂ or RuCl₃ and, if desired, promoters for doping, preferably in the form of their chlorides. Shaping of the catalyst can be carried out after or preferably before impregnation of the support material.

Promoters suitable for doping are alkali metals such as lithium, sodium, potassium, rubidium and cesium, preferably lithium, sodium and potassium, particularly preferably potassium, alkaline earth metals such as magnesium, calcium, strontium and barium, preferably magnesium and calcium, particularly preferably magnesium, rare earth metals such as scandium, yttrium, lanthanum, cerium, praseodymium and neodymium, preferably scandium, yttrium, lanthanum and cerium, particularly preferably lanthanum and cerium, or mixtures thereof.

The shaped bodies can be dried at, for example, from 100 to 400° C., for example under a nitrogen, argon or air atmosphere, and if appropriate calcined. The shaped bodies are preferably firstly dried at from 100 to 150° C. and subsequently calcined at from 300 to 400° C., preferably in an air atmosphere.

The conversion of hydrogen chloride in the second oxidation stage c), based on the total conversion, is generally from 20 to 60%. The cumulative conversion of hydrogen chloride in the first and second oxidation stages is generally from 70 to 95%. Unreacted hydrogen chloride can be separated off and partly or wholly returned to the first oxidation zone.

A product gas stream IV comprising chlorine, unreacted oxygen, unreacted hydrogen chloride and water vapor is obtained.

In a part d) of the process, chlorine is isolated from the product gas stream IV. For this purpose, it is usual to carry out the steps d1) to d4):

d1) separating off hydrogen chloride and water from the product gas stream IV to give a gas stream V comprising chlorine and oxygen;

d2) drying the gas stream V;

d3) separating off an oxygen-containing stream from the gas stream V and, if desired, recirculating at least part of it as oxygen-containing recycle stream IIa to the first oxidation zone, leaving a chlorine-containing product stream VI;

d4) if appropriate, further purifying the chlorine-containing product stream VI.

Unreacted hydrogen chloride and water vapor can be separated off from the product gas steam IV by cooling to condense out aqueous hydrochloric acid. Preference is given to absorbing hydrogen chloride in dilute hydrochloric acid or water.

In one embodiment of the invention, the separation step d1) is carried out as described below. In this case, the product gas stream IV is brought into contact with water or dilute hydrochloric acid having a concentration c1 in an absorption zone and hydrogen chloride is absorbed therein, giving hydrochloric acid having a concentration of c2 and a gas stream V comprising chlorine and oxygen.

As absorption medium, it is possible to use any dilute hydrochloric acid which is not saturated with hydrogen chloride. Its concentration c1 will usually be up to 25% by weight of hydrogen chloride, for example about 15% by weight. The absorption temperature is usually from 0 to 150° C., preferably from 30 to 100 ° C., and the absorption pressure is usually from 0.5 to 20 bar, preferably from 1 to 15 bar.

This gives a gas stream V which comprises chlorine and oxygen or consists essentially of these gases. It usually still contains traces of moisture. It is therefore usually subjected to a drying step d2) in which the gas stream V is freed of traces of moisture by bringing it into contact with suitable desiccants. Suitable desiccants are, for example, concentrated sulfuric acid, molecular sieves or hygroscopic adsorbents.

In a further process step d3), an oxygen-containing stream is separated off from the gas stream V and can be at least partly recirculated as oxygen-containing recycle stream IIa to the oxidation zone. The oxygen is preferably separated off by distillation, usually at a temperature in the range from −20 to +50° C. and a pressure in the range from 1 to 20 bar in a distillation column having from 10 to 100 theoretical plates. The oxygen-containing recycle stream ha is frequently under a high pressure.

This leaves a chlorine-containing product gas stream VI which may subsequently be purified further.

The invention is illustrated below with the aid of the figure.

The figure shows the process flow diagram of one embodiment of the process of the present invention.

An oxygen-containing feed gas stream 1, a feed stream 2 comprising hydrogen chloride, and an oxygen-containing recycle stream 17 are fed into the fluidized-bed reactor 3 in which part of the hydrogen chloride is oxidized to chlorine. The resulting stream 4 comprising oxygen, chlorine, unreacted hydrogen chloride and water vapor is fed into the shell-and-tube reactor 5. This contains a fixed catalyst bed. A product gas stream 6 comprising chloride, unreacted oxygen, unreacted hydrogen chloride and water vapor is obtained. The product gas stream 6 is introduced into a cooler/condenser 7, which can be configured as a quench cooler. Hydrochloric acid 9 is condensed out in the cooler 7. If desired, water 8 can be fed into the quench cooler 7 as quench or absorption medium and a substream 9a of the dilute hydrochloric acid can be recirculated to the quench cooler as quenching medium. A gas stream 10 which is essentially free of hydrogen chloride and comprises chlorine and oxygen and traces of water vapor leaves the quench cooler 7 and is passed to a drying stage 11. In the drying stage 11, the gas stream 10 is brought into contact with a suitable absorption medium such as sulfuric acid, molecular sieves or another hygroscopic adsorbent and is thus freed of traces of water. The drying stage 11 can be carried out in a drying tower or a plurarity of parallel drying towers which are regenerated alternately. The dried gas stream 12 or 14 (a compressor 13 may optionally be provided) comprising chlorine and oxygen is fed into a condenser 15 in which oxygen is separated off and is recirculated as recycle stream 17 to the hydrogen chloride oxidation reactor. A product gas stream 16 comprising chlorine is obtained. The liquid crude chlorine product is preferably purified by distillation. To avoid accumulation of inert gas constituents, a purge stream 17a is provided.

1. A process for preparing chlorine by catalytic gas-phase oxidation of hydrogen chloride, which comprises the steps:
a) providing a feed gas stream I comprising hydrogen chloride and a feed gas stream II comprising oxygen;
b) in a first oxidation stage, feeding the feed gas stream I, the feed gas stream II, if into a first oxidation zone and bringing them into contact with a first oxidation catalyst so that a first partial amount of the hydrogen chloride is oxidized to chlorine and a gas stream III comprising chlorine, unreacted oxygen, unreacted hydrogen chloride and water vapor is obtained;
c) in a second oxidation stage, feeding the gas stream III into a second oxidation zone and bringing it into contact with at least one further oxidation catalyst so that a second partial amount of the hydrogen chloride is oxidized to chlorine and a product gas stream IV comprising chlorine, unreacted oxygen, unreacted hydrogen chloride and water vapor is obtained;
d) isolating chlorine, from the product gas stream IV,
wherein the first oxidization catalyst in the first oxidation zone is present in a fluidized bed and the further oxidation catalyst or catalysts in the second oxidation zone is/are present in a fixed bed.

2. The process as claimed in claim 1, wherein the temperature in the first oxidation zone is from 280 to 360° C. and that in the second oxidation zone is from 220 to 320° C.

3. The process as claimed in claim 1, wherein the second oxidation zone comprises only one fixed-bed reactor.

4. The process as claimed in claim 1, wherein the second oxidation zone has only one temperature zone.

5. The process as claimed in claim 1, wherein the oxidation catalysts comprise ruthenium oxide on a support selected from among silicon dioxide, aluminum oxide, titanium dioxide and zirconium dioxide.

6. The process as claimed in claim 1, wherein step d) comprises the steps:
d1) separating off hydrogen chloride and water from the product gas stream IV to give a gas stream V comprising chlorine and oxygen;
d2) drying the gas stream V;
d3) separating off an oxygen-containing stream from the gas stream V, leaving a chlorine-containing product stream VI;
d4) and purifying the chlorine-containing product stream VI.

7. The process as claimed in claim 1, wherein a stream Ia comprising hydrogen chloride is recycled into the first oxidation zone.

8. The process as claimed in claim 1, wherein a stream Ia comprising oxygen is recycled into the first oxidation zone.

9. The process as claimed in claim 5, wherein at least part of oxygen-containing stream is recycled to the first oxidation zone.
